(19) United States
(12) Patent Application Publication
(10) Pub. No.: US 2017/0078769 A1
(43) Pub. Date: Mar. 16, 2017

(54) Remote Level Sensor for a Liquid Tank

(71) Applicant: Jared Theberge, New Gloucester, ME (US)

(72) Inventor: Jared Theberge, New Gloucester, ME (US)

(21) Appl. No.: 15/262,782

(22) Filed: Sep. 12, 2016

Related U.S. Application Data
(60) Provisional application No. 62/216,624, filed on Sep. 10, 2015.

(51) Int. Cl. H04Q 9/00; G08B 5/36; G08B 3/10; G08B 21/18; G01F 23/296; G01F 23/292

(52) U.S. Cl. CPC H04Q 9/00; G01F 23/2962; G01F 23/292; G08B 3/10; G08B 21/182; G08B 5/36; H04Q 2209/823; H04Q 2209/43; H04Q 2209/88

(57) ABSTRACT

A remote level sensor for a liquid tank. The remote level sensor for a liquid tank comprises a housing having a wireless transmitter, a sensor and a power source. The housing is configured to be mounted within the interior of a tank. The sensor detects the level of contents within the tank and transmits the level information via wireless signal to a receiving unit. The receiving unit comprises a display and is configured to present the level to a user. An auditory alarm can be configured to sound if the level of the tank falls below a predetermined threshold. Further, some embodiments of the receiving unit e configured to display additional information, such as local gas merchants and the current price of oil.

### CROSS REFERENCE TO RELATED APPLICATIONS

This application claims the benefit of U.S. Provisional Application No. 62/216,624 filed on Sep. 10, 2015. The above identified patent application is herein incorporated by reference in its entirety to provide continuity of disclosure.

### BACKGROUND OF THE INVENTION

The present invention relates to remote level sensors. Many residential and commercial buildings are heated with petroleum products such as oil or natural gas. Some heating systems include a tank that holds the oil or gas and must be refilled when empty. A building owner must be cognizant of the level within such tanks to ensure that they are not depleted or risks having the heating system fail. While many tanks feature various indicators such as gauges and electronic displays, these may fail without warning, especially in colder months when their mechanical parts may freeze and electronics may work more slowly. Such a scenario may lead to the tank running empty without the owner knowing. Beyond the obvious danger of having no heat source, a tank owner may be required to purchase fuel at a more expensive rate when doing so on short term notice. Furthermore, many building owners require the ability to monitor tank levels remotely. For example, when a home owner is travelling for extended periods of time they may wish to keep track of the fuel levels within their tank from their travel destination. The same applies to landlords who do not live close to their rental buildings. Accordingly, a device capably of relaying tank levels remotely is desired.

### SUMMARY OF THE INVENTION

In view of the foregoing disadvantages inherent in the known types of tank measurement devices now present in the prior art, the present invention provides a tank measurement device wherein the same can be utilized for providing convenience for the user by relaying the internal level of contents of a tank via a wireless signal. The present system comprises a remote level sensor having a housing with a wireless transmitter, a sensor and a power source. The housing is configured to be mounted within the interior of a tank. The sensor detects the level of the contents of the tank and transmits the level information via wireless signal to a receiving unit. The receiving unit comprises a display and is configured to present to tank level to a user. Further, some embodiments of the receiving unit are configured to display additional information, such as local gas merchants and the current price of oil.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic view of the remote level sensor for a liquid tank.

FIG. 2 shows a schematic view of the display unit of the remote level sensor for a liquid tank.

FIG. 3 shows a schematic view of a mobile electronic device displaying information from the remote level sensor for a liquid tank.

FIG. 4 shows a cut-away perspective view of the remote level sensor for a liquid tank mounted within a liquid tank.

### DETAILED DESCRIPTION OF THE INVENTION

Reference is made herein to the attached drawings. Like reference numerals are used throughout the drawings to depict like or similar elements of the remote level sensor for a liquid tank. The figures are intended for representative purposes only and should not be considered to be limiting in any respect.

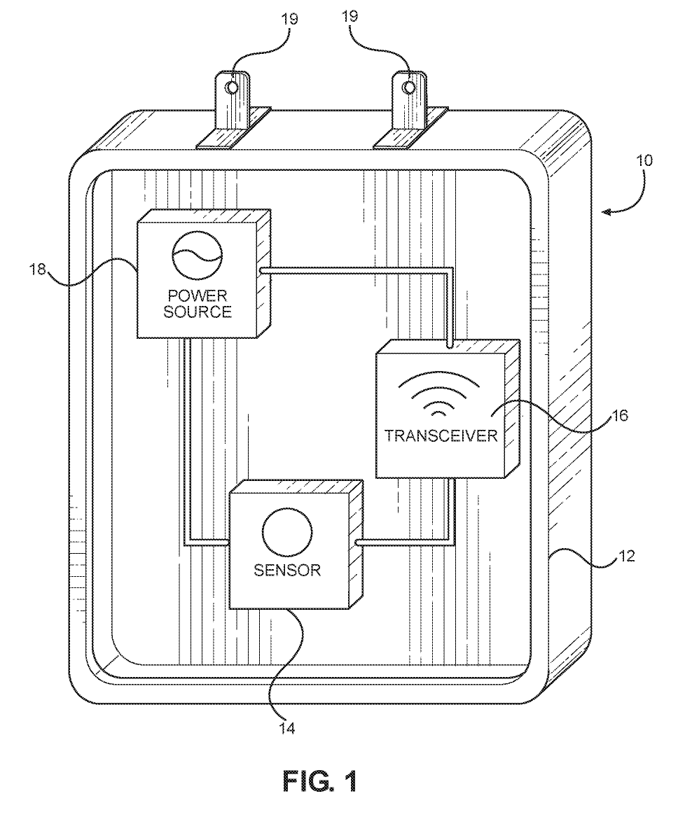

Referring now to FIG. 1, there is shown a schematic view of the remote level sensor for a liquid tank. The remote level sensor 10 comprises a housing 12 forming an interior. A sensor 14 is disposed on the housing 12 and is operably connected to a power source 18. A wireless transmitter 16 is disposed within the interior of the housing 12 and is operably connected to the power source and the sensor 14. In one embodiment, the housing 12 forms an enclosed interior volume containing the sensor 14, the transceiver 16, the power source 18, and the other electronic components of the device so that they do not make contact with the liquid contents of the tank in which the sensor 10 is disposed. In this embodiment of the level sensor 10, the power source 18 can be a battery disposed within the housing 12. In an alternative embodiment of the level sensor 10, the power source 18 is an external power supply. A fastener 19 is disposed on the housing 12 and configured to removably mount the housing 12 to an interior wall of a tank, such as a liquid oil tank. In one embodiment of the remote level sensor 10, the fastener 19 is a right angle bracket configured to be secured to the interior of a tank with screws or other fasteners. In some embodiments of the remote level sensor, the housing 12 forms a cylindrical shape having a diameter that is adapted to fit within an outlet of a standard sized oil tank.

The sensor 14 is configured to detect the level of liquid content within the tank. In one embodiment of the remote level sensor 10, the sensor 14 is an ultrasonic sensor configured to emit ultrasonic waves. The waves emitted by the sensor 14 bounce off the surface of the tank contents and are then detected by the ultrasonic sensor 14. The time interval required for the waves to travel from the ultrasonic sensor to the tank contents and back to the ultrasonic sensor is used to calculate the precise level of contents remaining in the tank. In another embodiment of the remote level sensor 10, the sensor 14 is an optical sensor configured to measure the level of tank contents via an electromagnetic wave using a similar method of calculation.

The wireless transmitter 16 is configured to relay a wireless signal containing information regarding the level of contents within the tank to a remote receiving unit. In one embodiment of the remote level sensor 10, the information is relayed using the Bluetooth wireless standard. In another embodiment of the remote level sensor 10, the 802.11 wireless standard is used.

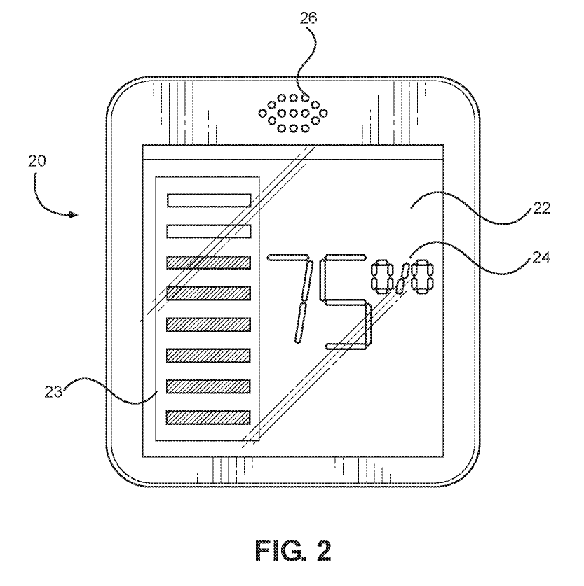

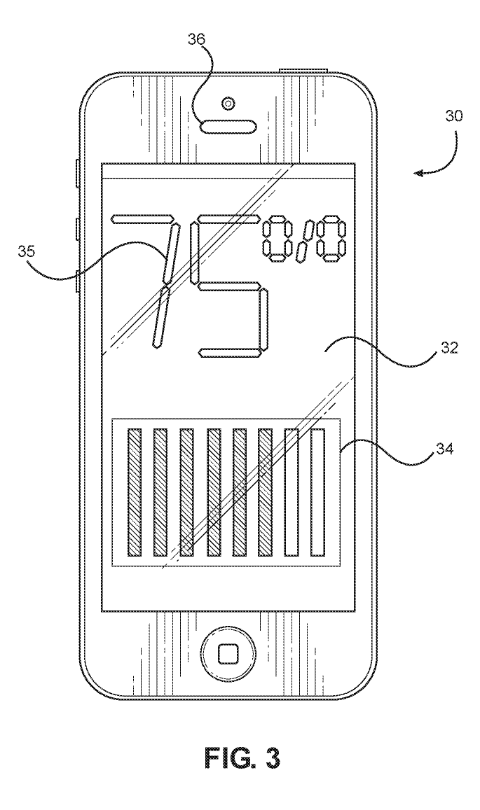

Referring now to FIGS. 2 and 3, there are shown a schematic view of a display unit of the remote level sensor for a liquid tank and of a mobile electronic device, respectively. In one embodiments of the remote level sensor 10, the remote receiving unit is a display unit 20 configured to display the level of the contents of the tank. In one embodiment, the display unit comprises a screen 22 and a wireless receiver. The level information is received by the wireless receiver from the wireless transmitter 16 and is displayed on the screen 22. The level can be shown as a graphic display 23 or in numerical notation 24. Further embodiments of the display unit comprise an audio speaker 26 configured to emit an auditory alert when the level within the tank reaches a predetermined threshold amount, thus indicating to a user that the tank requires replenishing.

In an alternative embodiment of the remote level sensor 10, the remote receiving unit is a mobile electronic device such as a cellular phone 30. The cellular phone 30 receives the wireless signal with the level information and is configured to display the level of the tank on a screen 32 through a software application. The application can be configured to show a graphical 34 or numeric 35 representation of the level within the tank. The application can be modified to sound an audio alert through internal speakers of the cellular phone 30 to notify a user when the tank reaches a predetermined level. Additionally, the application can provide further information received from an external telecommunications network, such as the location of local oil merchants and the current cost of oil from the internet.

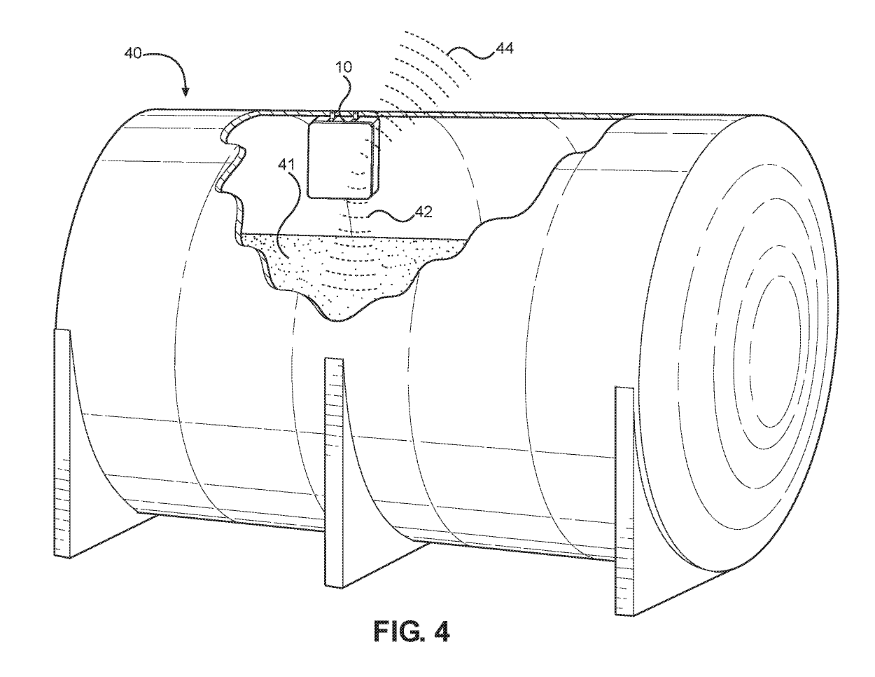

Referring now to FIG. 4, there is shown a cut-away perspective view of the remote level sensor for a liquid tank mounted within a liquid tank. In use, the remote level sensor 10 is mounted onto an interior wall of a tank, such as an oil tank 40. The sensor 10 measures the oil level 41 of the tank through a wireless signal 42, such as an ultrasonic or optic wave. In some embodiments, the remote level sensor 10 is configured to measure the level of the contents 41 of the tank at a predetermined repeating interval of time, such as once per day. The calculated level is then wirelessly transmitted 44 to the remote receiving unit, where a user can be alerted should the oil level of the tank fall below a threshold amount.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A remote level sensor for a liquid tank, comprising:
a housing forming an enclosed interior;
a fastener disposed on the housing, the fastener removably securable to an interior surface of the liquid tank;
a power source disposed within the enclosed interior;
a sensor disposed on the housing and operably connected to the power source, wherein the sensor is configured to detect a level of liquid contents within the liquid tank;
a wireless transmitter disposed within the enclosed interior and operably connected to the power source and the sensor, wherein the wireless transmitter is configured to relay a signal indicating the level of the liquid contents to a remote display.

2) The remote level sensor for a liquid tank of claim 1, wherein the sensor comprises an ultrasonic sensor.

3) The remote level sensor for a liquid tank of claim 1, wherein the sensor comprises an optical sensor.

4) The remote level sensor for a liquid tank of claim 1, wherein the wireless transmitter is a Bluetooth transmitter.

5) The remote level sensor for a liquid tank of claim 1, wherein the wireless transmitter uses an 802.11 wireless communication standard to transmit the signal.

6) The remote level sensor for a liquid tank of claim 1, wherein the remote display comprises:
a housing;
a wireless receiver disposed within the housing and configured to receive the wireless signal transmitted by the wireless transmitter;
a screen configured to display the level of the liquid contents.

7) The remote level sensor for a liquid tank of claim 6, wherein the remote display is further configured to display a visual alert when the sensor detects that the level of the liquid contents has reached a predetermined level.

8) The remote level sensor for a liquid tank of claim 6, further comprising an audio speaker, wherein the audio speaker is configured to emit an auditory alert when the sensor detects that the level of the liquid contents has reached a predetermined level.

9) The remote level sensor for a liquid tank of claim 1, wherein the remote display is a mobile electronic device running a software application.

10) The remote level sensor for a liquid tank of claim 9, wherein the mobile electronic device is configured to display a visual alert when the sensor detects that the level of the liquid contents has reached a predetermined level.

11) The remote level sensor for a liquid tank of claim 7, wherein the mobile electronic device is configured to activate an auditory alert when the sensor detects that the level of the liquid contents has reached a predetermined level.
